(19) United States
(12) Patent Application Publication
(10) Pub. No.: US 2011/0282891 A1
(43) Pub. Date: Nov. 17, 2011

(54) Methods And Apparatuses For Providing A Search Crowd Capability

(75) Inventor: Reiner Kraft, Santa Clara, CA (US)

(73) Assignee: Yahoo! Inc., Sunnyvale, CA (US)

(21) Appl. No.: 12/779,718

(22) Filed: May 13, 2010

(51) Int. Cl. G06F 17/30; G06Q 99/00

(52) U.S. Cl. 707/765; 705/319; 707/E17.014

(57) ABSTRACT

Exemplary methods and apparatuses are provided which may be implemented using one or more computing devices within a networked computing environment to identify certain shared search interests and to provide additional search capabilities based thereon to a plurality of users in a social search manner. For example, a “search crowd” capability and information may be provided based on a plurality of related search queries received from two or more users. A number of determining factors may be considered to identify, establish, maintain, and/or otherwise manage a search crowd and related information.

### BACKGROUND

1. Field

The subject matter disclosed herein relates to data processing.

2. Information

Data processing tools and techniques continue to improve. Information in the form of data is continually being generated or otherwise identified, collected, stored, shared, and analyzed. Databases and other like data repositories are common place, as are related communication networks and computing resources that provide access to such information.

The Internet is ubiquitous; the World Wide Web provided by the Internet continues to grow with new information seemingly being added every second. To provide access to such information, tools and services are often provided which allow for the copious amounts of information to be searched through in an efficient manner. For example, service providers may allow for users to search the World Wide Web or other like networks using search engines. Similar tools or services may allow for one or more databases or other like data repositories to be searched.

With so much information being available and often changing over time and the incredible number of users, there is a continuing need for methods and apparatuses that allow for certain information to be easily identified and shared in an efficient manner.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic block diagram illustrating an example implementation of a networked computing environment having one or more computing devices operatively enabled to provide a search crowd capability while searching for information in one or more electronic documents, in accordance with certain example implementations.

FIG. 2 is a schematic block diagram illustrating certain features of an example computing device that may be operatively enabled to provide and/or support a search crowd capability, in accordance with certain example implementations.

FIG. 3 is a functional block diagram illustrating techniques that may be implementable in a networked computing environment to provide and/or support a search crowd capability, in accordance with certain example implementations.

FIG. 4 is a flow diagram illustrating a process implementable in one or more service provider and/or other like computing devices operatively enabled to provide a search crowd capability, in accordance with certain example implementations.

FIG. 5 is a flow diagram illustrating a process implementable in one or more user computing devices and/or the like operatively enabled to support and/or otherwise make use of a search crowd capability, in accordance with certain example implementations.

FIG. 6 is an illustrative diagram showing an example search crowd capability as may be represented by computer-readable instructions and/or data and rendered via a display device to present search crowd information and/or related capabilities to a user, in accordance with certain example implementations.

### DETAILED DESCRIPTION

In accordance with certain example aspects, techniques are provided which may be implemented in various methods and apparatuses within a networked computing environment to identify certain shared search interests and to provide additional search capabilities based thereon. A shared search interest may, for example, be identified as a subject or topic that two or more users may be searching for through an online search engine and/or other like capability at the same time and/or during at least a given period of time. Users that have such a shared search interest may, for example, be able to help one another in their searching and/or provide valuable input regarding the search process and/or the subject or topic of interest.

Thus, in accordance with certain example aspects, methods and apparatuses are provided to promote such a search and social networking environment/experience to users. These methods and apparatuses may, for example, identify a “search crowd” which may have varying numbers of “members” with which search crowd information may be provided, collected, and/or otherwise shared.

For example, as described in greater detail in the example implementations below, a search engine provider and/or other like service provider may monitor search queries to identify that a search crowd capability may be beneficial. Here, for example, a server or other like computing device(s) may identify a search crowd based, at least in part, on a plurality of related search queries received from two or more user devices/accounts. In the following sections, a number of determining factors are presented which may be considered to identify, establish, maintain, and/or otherwise manage a search crowd.

Once a search crowd has been identified, information associated with the search crowd may be established and maintained. For example, information may be established which may provide for a social network search atmosphere among a plurality of users. Thus, for example, current and future members of a search crowd may be presented with and/or otherwise selectively access and/or interact with search crowd information.

In certain instances, for example, members of a search crowd may provide information and/or otherwise seek to affect the information associated with a search crowd. Thus, for example, a search crowd capability and information may promote refinement and/or improvement in one or more search queries and/or search results. A search crowd capability and information may, for example, be used to alter or otherwise affect or possibly augment search results and/or the presentation thereof. A search crowd capability and information may, for example, provide for sharing of member comments and/or promoting additional inter-member communications. A search crowd capability and information may, for example, provide for gathering of member voting and/or other like user inputs, etc.

In certain instances, for example, a search crowd capability and information may be further considered to provide additional information and/or search results that may be of particular interest to one or more members of a search crowd (e.g., focused advertisements, announcements, breaking news, further social networking capabilities, etc.).

In certain instances, for example, a search crowd capability and information may be further provided to identify new or additional search crowds, combine existing search crowds, and/or split an existing search crowd into two or more search crowds.

By way of initial example but not limitation, a search crowd may be identified by accessing a search query log and identifying that two or more search queries are related, and establishing at least one search cluster (e.g., using a similarity function, clustering algorithm, and/or the like). A search crowd may be identified as comprising and/or otherwise being associated with one or more such search clusters. In certain example implementations a described herein, a search crowd may be identified based, at least in part, on one or more threshold values. Such threshold values may be statically or dynamically set.

For example, a measured time threshold value may be considered to determine if a search cluster is or may become of interest to current and/or potential future members. A measured time threshold may, for example, relate to a finite period of time (e.g., previous 25 minutes, etc.), a specific period of time (e.g., 1-2 PM EST, one or more days or dates, etc.), and/or other like temporal measurable values.

In another example, a threshold value may be compared to a number of received search queries associated with a search cluster. For example, a threshold value may be employed to establish a minimum number or range of numbers of received (related) search quires to be eligible for a search crowd to be formed and/or maintained in some capacity. In yet another example, a threshold value may be compared to a measured, estimated or expected number of current and/or potential future search crowd members to help determine whether a new search crowd should be formed and/or an existing search crowd maintained in some capacity.

In certain example implementations, a plurality of threshold based determinations may be used to determine how to form and/or otherwise maintain or manage a search crowd, search crowd information and/or related services.

As mentioned above and further illustrated below, in certain example implementations herein a search engine and/or other like service provider may associate one or more search results and/or search result summaries with a search crowd. For example, at least the portion of a search result response provided to a member of a search crowd may operatively affect a presentation of at least one of the search results and/or search result summaries as rendered on a display device of a user computing device. In certain example implementations, search crowd information may be provided as part of an on-going session in which search results and/or other search crowd related information and/or search crowd capability tools or services may be presented to members, e.g., in a social networking and/or otherwise collaborative user environment.

Thus, in certain example implementations, a search crowd capability and information may associate one or more search results and/or search result summaries with a search crowd, assign an identifier to the search crowd, and identify at least one user account and/or user device as a member of the search crowd. In certain instances, for example, members of a search crowd may further be designated in some manner, e.g., as being either “active” or “inactive” members. Here, for example, an active member may be deemed to be currently interacting with a search crowd capability and/or information in some timely manner. Conversely, an inactive member may be deemed to be not currently interacting with a search crowd capability and/or information in a timely manner (e.g., such user may be lurking). Different amounts or types of search crowd information and/or search crowd capability tools or services may be presented to different members. For example, active members may be provided with more or timelier search crowd information, etc., than might an inactive member. For example, certain members may be provided with different search crowd information, etc., based, at least in part, on one or more selected user inputs (e.g., a member may ask for more or less information/services) and/or certain user related information (e.g., certain search crowd information may be altered, removed, added, etc., based on a user preference, location, computing device, network connection, etc.).

In certain example implementations, one or more search crowds may be maintained (e.g., indefinitely, for a period of time, etc.) regardless of the number of currently active and/or inactive members. Thus, for example, a search crowd may still be maintained should its number of search crowd members fall to zero. In still other example implementations, a search crowd may be inactivated, reactivated, or otherwise affected in some manner based, at least in part, at least one threshold value.

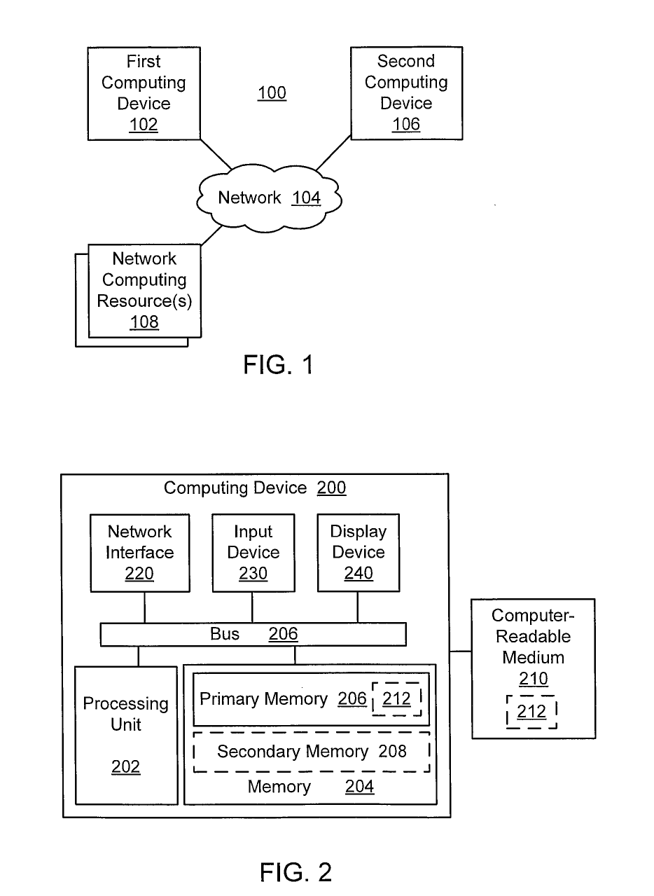

Reference is now made to FIG. 1 which illustrates an example computing environment 100 having a first computing device 102 coupled to a network 104. By way of example but not limitation, first computing device 102 may include one or more servers or other like computing devices enabled to communicate with a second computing device 106, and/or one or more network computing devices 108 through network 104. By way of example but not limitation, first computing device 102 may include one or more servers or other like computing devices enabled to provide and/or support a search engine and/or other like service provider capability with a search crowd capability and related information. Here, for example, a search engine and/or other like service provider capability may be enabled to search for electronic information available via one or more network computing resources 108 through network 104.

Second computing device 106 may, for example, include a client or other like computing device through which a user may interact to access other devices and services that may be available within computing environment 100. By way of example but not limitation, second computing device 106 may include a personal computer, a workstation, a laptop computer, a net book, a personal digital assistant (PDA), a smart phone, a kiosk, and/or other like devices. In certain example implementations, second computing device may include a display device through which a graphical user interface (GUI) and/or other like application or process may be employed and information in an electronic document presented to a user for interaction (e.g., during a search process). Here, for example, a browser or other like application or process may be implemented via a GUI in a manner for presenting visual information to a user, obtaining user inputs (e.g., via a keyboard, mouse, pointer, touch screen, microphone, etc.), and/or supporting communication exchanges with various devices and/or services available within computing environment 100.

Network 104 may represent one or more communication networks and/or other like systems. For example, network 104 may include one or more wired and/or wireless telecommunication systems or networks, one or more local area networks or the like, an intranet, the Internet, etc. In certain example implementations, network computing resources 108 may represent one or more computing devices and/or services from which various types/forms of files and/or electronic documents may be downloaded, or conversely uploaded to. By way of example but not limitation, network computing resources may include one or more servers and/or other like computing devices which host various websites, web pages, databases, and/or other like communication and/or information related services.

For the sake of brevity, the term “electronic document” as used herein is intended to broadly represent any form of information, such as, e.g., data and/or executable instructions or other like functionality, that computing devices within computing environment 100 may exchange over network 104. Thus, for example, certain “electronic documents” may comprise a web page, an executable script or other like computer executable code, a text file, a graphs file, an image file, a video file, an audio file, or the like, and/or any combination thereof. Some example electronic documents may include electronic documents associated with certain computer applications/services, such as, e.g., a browser, a word processor, a drawing application, a spreadsheet or other like application, a presentation application, etc. As is well known, such “electronic documents” may be communicated between one or more computing devices in accordance with various applicable communication techniques and protocols. Furthermore, such “electronic documents” may be encoded using various techniques, e.g., as may be useful with regard to processing, storage, communication, security, and/or other like concerns.

While terms such as, e.g., database, browser, application, GUI, server, and client, are used in some of the examples presented herein to illustrate certain traditional computing functionality, it should be clear that the techniques provided herein are not necessarily limited to such example implementations and/or traditional computing functionality.

Reference is made next to FIG. 2, which shows an example computing device 200 that may take the form, at least in part, of first computing device 102, second computing device 106, and/or portions of network computing resources 108 as illustrated in FIG. 1.

Computing device 200 may, for example, include one or more processing units 202, memory 204 and at least one bus 206.

Processing unit 202 is representative of one or more circuits configurable to perform at least a portion of a data computing procedure or process. By way of example but not limitation, processing unit 202 may include one or more processors, controllers, microprocessors, microcontrollers, application specific integrated circuits, digital signal processors, programmable logic devices, field programmable gate arrays, and the like, or any combination thereof.

Memory 204 is representative of any data storage mechanism. Memory 204 may include, for example, a primary memory 206 and/or a secondary memory 208. Primary memory 206 may include, for example, a solid state memory such as a random access memory, read only memory, etc. While illustrated in this example as being separate from processing unit 202, it should be understood that all or part of primary memory 206 may be provided within or otherwise co-located/coupled with processing unit 202.

Secondary memory 208 may include, for example, the same or similar type of memory as primary memory and/or one or more data storage devices or systems, such as, for example, a disk drive, an optical disc drive, a tape drive, a solid state memory drive, etc. In certain implementations, secondary memory 208 may be operatively receptive of, or otherwise configurable to couple to, a computer-readable medium 210. Computer-readable medium 210 may include, for example, any media that can carry and/or make accessible data, code and/or instructions 212 for use, at least in part, by processing unit 202 and/or other circuitry within computing device 200.

Computing device 200 may include, for example, a network interface 220 that provides for or otherwise supports the operative coupling of computing device 200 to at least one network and/or other computing device. Network interface 220 may, for example, be coupled to bus 106. By way of example but not limitation, network interface 220 may include a network interface device or card, a modem, a router, a switch, a transceiver, and/or the like.

Computing device 200 may include, for example, at least one input device 230. Input device 230 is representative of one or more mechanisms and/or features that may be configurable to accept user input. Input device 230 may, for example, be coupled to bus 106. By way of example but not limitation, input device 230 may include a keyboard, a keypad, a mouse, a trackball, a touch screen, a microphone, etc., and applicable interface(s).

Computing device 200 may include, for example, at least one display device 240. Display device 240 is representative of one or more mechanisms and/or features for presenting visual information to a user. Display device 240 may, for example, be coupled to bus 106. By way of example but not limitation, display device 240 may include a liquid crystal display (LCD) monitor, a cathode ray tube (CRT) monitor, a projector, and/or the like.

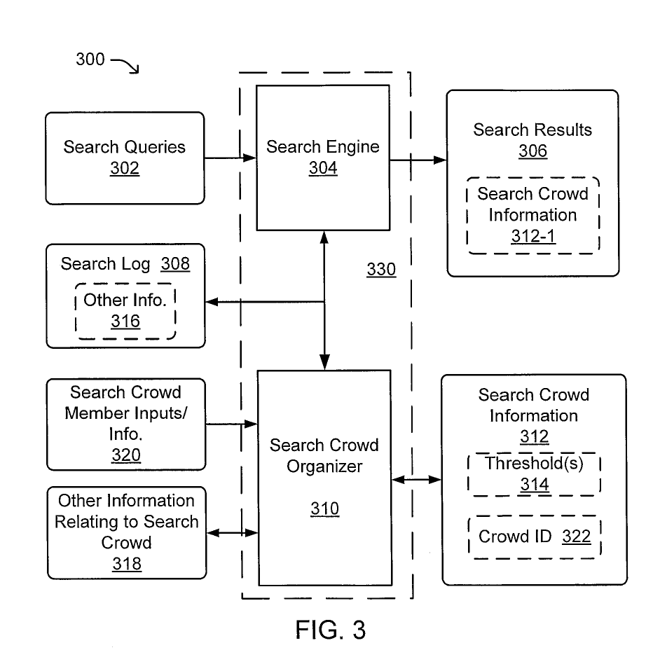

Reference is made next to FIG. 3, which is a block diagram of an example search crowd capability process 300 as represented by certain example functions and/or features associated with a first computing device and a second computing device (e.g., as shown in FIG. 1). It should be understood that this is one example and that all or part of one or more of the functions and/or features may be operatively associated with one or more other computing devices, processing units, etc. It is also recognized that in certain example implementations, one or more computing devices may act as all, part, or both of first and second computing devices.

As illustrated, a plurality of search queries 302 may be received over a period of time by a search engine 304. Search queries 302 may, for example, comprise information associated with one or more search terms as entered or otherwise specified by a user. Search queries 302 may, for example, be represented in a search log 308 comprising such query related information gathered from a plurality of user computing devices/accounts.

Search engine 304 may be enabled to respond to a search query by returning applicable information associated with one or more search results 306 and/or search result summaries, etc. Such search query entries and search result responses are well known, for example, Yahoo!, Bing, and Google search engine capabilities are available. However, as described herein search crowd information 312-1 may also be provided as part of search results 306.

As illustrated in FIG. 3, a search crowd organizer 310 may also be provided to access search log 308, for example. Search crowd organizer 310 may, for example, identify a search crowd based, at least in part, on related search query information in search log 308. For example, a frequency or popularity of a search term or phrase or topic may be determined, possibly over a defined or specific period of time, and compared to one or more corresponding threshold values to determine whether a search crowd may be identified.

Search crowd organizer 310 may, for example, establish and/or otherwise maintain search crowd information 312. Search crowd information 312 may include threshold value(s) 314 which may be used to initially identify a search crowd and/or to determine how to manage and existing search crowd. As illustrated, a search crowd may be associated with a search crowd identifier 322 (e.g., a unique ID).

Further, as illustrated in this example, search crowd organizer 310 may obtain information 318 relating to one or more given search crowds. For example, information 318 may comprise further specific and/or aggregated search query and/or search result information gathered over a period of time from search engine 304, and/or from other (not shown) capabilities/services For example, information 318 may comprise information that may be of interest to a given search crowd.

In certain example implementations, search crowd organizer 310 may obtain further information 320 associated with search crowd members (e.g., demographic information) and/or search crowd related member inputs (e.g., comments, votes, additional search query terms, links, etc). Here, for example, information 320 may be provided to search crowd organizer 310 from a member's user computing device, and/or via search engine 304 and/or some other like capability.

In certain example implementations, search log 308 may comprise other information 316. For example, information 316 may comprise time stamp related information, location information, user computing device related information, user account related information, e.g., gathered over a period of time from search engine 304 along with search query information.

Search crowd organizer 310 may establish search crowd information 312 based, at least in part, on search information available in search log 308, information 318 and/or 320, and/or other information available via search engine 304. Search crowd information 312 may, for example, include any information and/or instructions that may relate to and/or be of potential interest to a search crowd, search cluster, and/or one or more members thereof. In certain example implementations, a portion of search crowd information 312 may be presented and/or used in some manner to present information to one or more members. In certain example implementations, a portion of search crowd information 312 may be presented and/or used in some manner to analyze a search process or capability, e.g., associated with a search crowd, search cluster, etc. Search crowd organizer 310 may establish search crowd information 312 based, at least in part, on information that may be of interest to members of the search crowd and which may be available in electronic files accessible via networking computing resources 108 (FIG. 1).

As shown, at least a portion of search crowd information 312-1 may be provided in search results 306 and/or otherwise communicated to a user computing device. Here, in certain example implementations, search results 306 may be provided with search crowd information 312-1 (e.g., session information) to a user computing device regardless as to whether the user/user account may or may not be currently deemed to be a search crowd member (active or inactive). As such, in certain implementations, search crowd information 312-1 may be provided to notify a user that a search crowd has been established. The user may then selectively become a member (active or inactive) at their option. In other implementations, for example, search crowd information 312-1 may be provided and as a default (or in accordance with other privacy agreements), a user may automatically become either an active or inactive member of the search crowd. In certain other example implementations, search crowd information 312-1 may identify and/or otherwise be related to a plurality of different search crowds.

As illustrated, search engine 304 and search crowd organizer 310 may be provided as separate services/capabilities or may be operatively combined as part of a service capability 330 enabled via one or more computing devices.

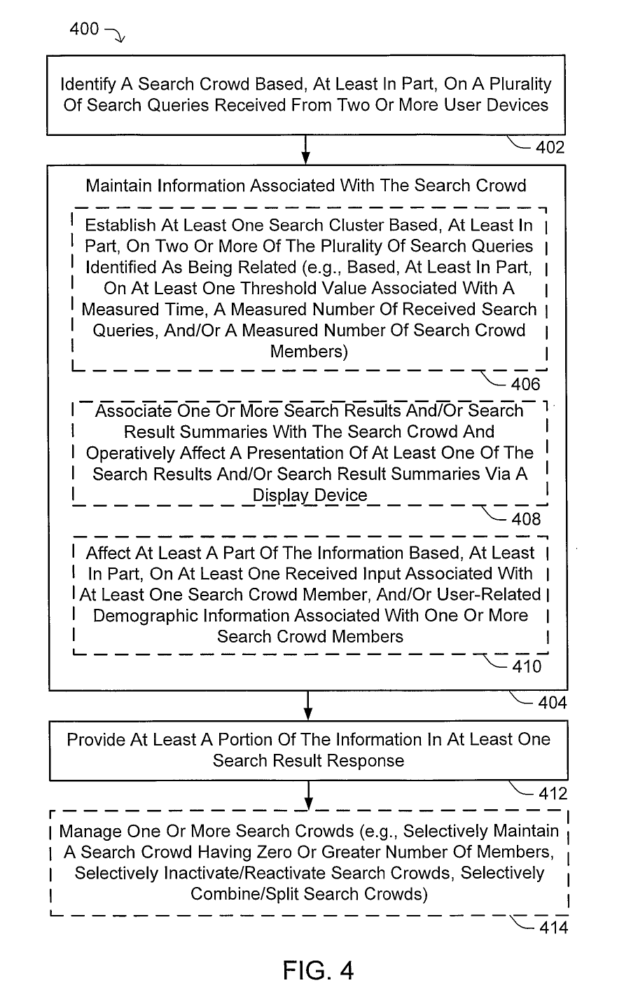

Reference is made next to FIG. 4, which is a flow-diagram illustrating a process 400 that may, for example, be implemented using search crowd organizer 310 (FIG. 3) and/or one or more computing devices.

At block 402, a search crowd may be identified based, at least in part, on a plurality of search queries received from two or more user devices. At block 404, information associated with the search crowd may be maintained.

By way of example but not limitation, at block 406, at least one search cluster may be established based, at least in part, on two or more of the plurality of search queries identified as being related. Here, for example, search queries may be identified as being related based, at least in part, on at least one threshold value associated with a measured time, a measured number of received search queries, and/or a measured number of search crowd members.

By way of example but not limitation, at block 408, one or more search results and/or search result summaries may be associated with a search crowd and used in some manner to operatively affect a presentation of at least one of the search results and/or search result summaries upon rendering via a display device.

By way of example but not limitation, at block 410, at least a part of the search crowd information may be affected based, at least in part, on at least one received input associated with at least one search crowd member, and/or user-related demographic and/or other like information associated with one or more search crowd members.

At block 412, in response to subsequently receiving at least one other search query associated with a search crowd, at least a portion of the applicable search crowd information may be provided within (and/or otherwise related to) at least one search result response.

At block 414, one or more search crowds may be selectively managed. Here, for example, a search crowd organizer may maintain a search crowd having zero or greater number of members, inactivate/reactivate search crowds, and/or selectively combine/split search crowds.

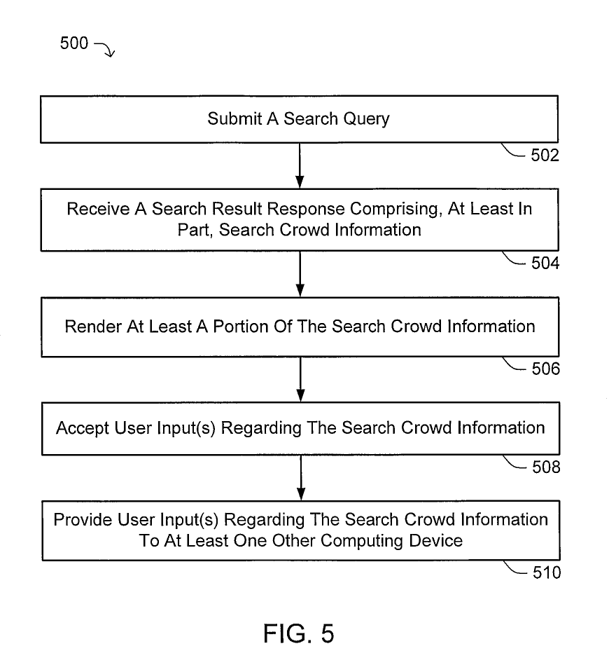

Reference is made next to FIG. 5, which is a flow-diagram illustrating a process 500 that may, for example, be implemented using a user computing device to become a member of a search crowd.

At block 502, one or more search queries may be provided to a search engine and/or other like capability coupled to, for example, a search crowd organizer 310 (FIG. 3). At block 504, one or more search result responses may be received comprising search crowd information. At block 506, at least a portion of the search crowd information may be rendered and/or otherwise processed to present search crowd information to a user.

At block 508, one or more user inputs regarding the search crowd information and/or search crowd capability may be accepted. For example, a user may opt to become an active (or inactive) member of a search crowd by providing applicable user inputs relating thereto.

At block 510, information gathered via user inputs at block 508 may be provided to one or more other computing devices. Here, for example, user inputted information regarding search crowd questions or comments may be transmitted over a network to a search engine and/or other like service capability providing a search crowd.

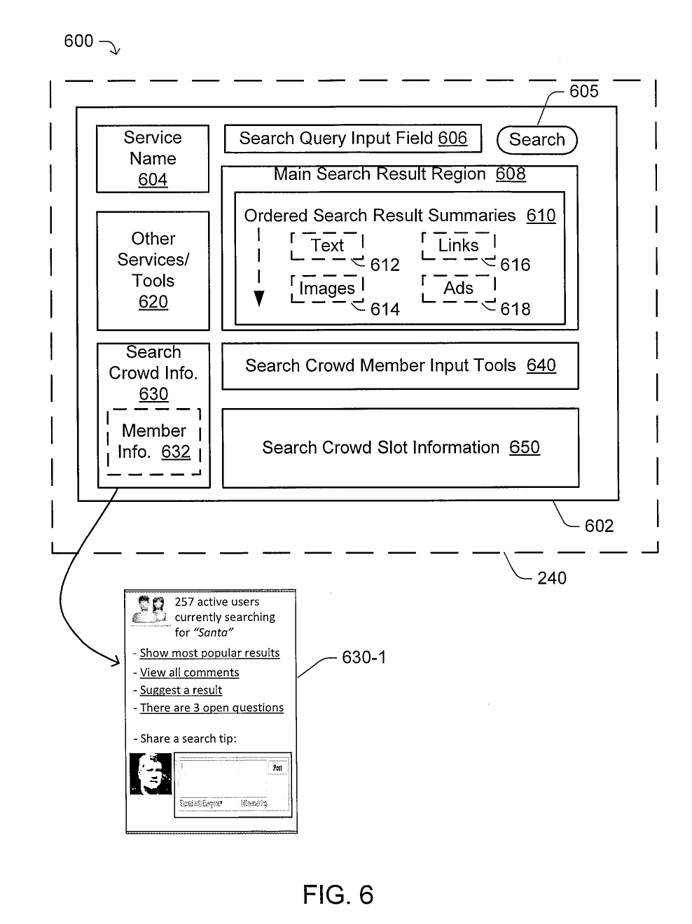

Reference is made next to FIG. 6, which is an illustrative diagram showing an example presentation 600 that may be viewed by (and possibly interacted with) a user of a user computing device.

Here, presentation 600 is shown as being rendered and displayed via a display device 240 (see FIG. 2) to include a window 602. Here, for example, window 602 may be presented within a GUI and/or browser as enabled to support a particular search engine and/or other like capability. Thus, for example, a service name 604 may identify the service, and a search query input field 606 provided to accept user input of one or more search terms. A selectable feature 605 may, for example, be provided to initiate a search based on an entered or otherwise selected search query. In response to a search query, for example, one or more search results or result summaries 610 may be presented in a main search result region 608. The search results or result summaries may, for example, be ordered and/or otherwise arranged in some manner, and/or may include text 612, image(s) 614, hyperlink(s) 616, advertisements 618, etc., as is well known. Further, for example, other services, features, and/or tools 620 may be presented in some manner as being selectable by the user, as is also well known.

Additionally, in this example, information relating to at least one identified search crowd may also be presented to a user. By way of example but not limitation, search crowd information 630, search crowd member selectable input tools 640, search crowd slot information 650, and/or any combination thereof, may be presented to convey at least a portion of a search crowd capability and/or information to a user. Search crowd information 630 may, for example, identify that a search crowd exists, describe the search crowd and/or its memberships or members in some manner, and/or invite the user to interact in some manner, become a search crowd member, leave a search crowd, etc. For example, user or member information 632 may be presented to the user here. An example is provided in the extracted box 630-1. Here, for example, a number of members (active) for a search crowd may be presented. Here, a search crowd with two hundred and fifty seven active users is interested in “Santa”. Several selectable links are provided also. For example, hyperlinks are provided for “Show most popular results”, “View all comments”, “Suggest a result”, and “There are 3 open questions”. An additional user input field is provided for posting information to other members of the group. Further in this example, member information is shown as having an image of the user. Of course, these are just some examples to which claimed subject matter is not limited. In certain example implementations, search crowd information 312 may comprise all or part of search crowd information 630, member input tools 640, and/or search crowd slot information 650.

Search crowd member input tools 640 may, for example, comprise other selectable links, pop-ups, etc., relating to a search crowd capability and/or information.

Search crowd slot information 650 may, for example, comprise one or more selected search results and/or search result summaries which may be considered of particular interest to one or more users/members and/or a search crowd. Search crowd slot information 650 may, for example, comprise targeted advertisements, news feeds, etc.

Furthermore, in certain example implementations, information presented in main search result region 608 may be affected in some manner based, at least in part, on search crowd information. Thus, for example, an ordering of search results and/or search result summaries may be changed based on search crowd information.

In still other example implementations, search crowd information may be presented in separate/dedicated or otherwise different window (not shown) to further enhance or support a social networking experience.

In still other example implementations, a search crowd and/or a portion of search crowd information may be associated with members that are in some manner further identifiable by some demographic information, location, user device type, etc. For example, in certain implementations, members that are using mobile devices (e.g., smart phones, etc.) may be identified in some manner as or within a search crowd based on location to further enhance a search experience and/or augment or otherwise further enhance a social networking experience. Here, for example, search crowd information may be provided that allows certain members of a search crowd to help one another in locating an place and/or item that is the subject of or result of a search process. For example, consider members of a search crowd using mobile devices in a given city to search for and locate a shopping bargain, a garage sale, a good cup of coffee, available lodging, etc. Here, search crowd information may be tailored in some manner to promote such search and location experience. Indeed, in certain instances some members of a search crowd may actually physically gather in and/or otherwise interact within an area to form an actual crowd as part of or in furtherance of some social searching/networking experience.

Those skilled in the art will recognize that it may be desirable for at least the search crowd information (e.g., session information) that is being presented to be updated in a “real-time” manner and/or sufficiently often to allow a plurality of members of a search crowd to interact with one another and/or the search crowd capability/information in a timely fashion.

In certain further example implementations, example search crowd information may comprise a cluster of related search queries, a search result list for each query, a set of active users who issued these queries in a current session, and possibly combined knowledge derived from their actions. Here, for example a search crowd may be identified with a current set of active users searching at this moment in time (e.g., 20-30 minutes), but may be extended to save historic data/derived crowd wisdom for later reuse. Here, for example a search crowd may lose all active members for a moment or period of time, but still exist (e.g., has an empty set of current active members). In certain example implementations, a cluster of related queries may be pre-computed (e.g., off-line) on a daily or other like basis, and/or certain result lists for these queries may be cached and added on demand.

In certain example implementations, it may be desirable for members and/or their actions to remain anonymous. Hence, while a list of members of a search crowd may remain anonymous, a “crowd” of current active members nonetheless may still work on the same or similar query topic, etc. For example, such anonymous members may act to vote up or down certain search results, etc., and a most popular result may be presented as search crowd slot information.

Thus, as illustrated in the various example implementations and techniques presented herein, in accordance with certain aspects a method may be provided for use as part of a special purpose computing device and/or other like machine that accesses digital signals from memory and processes such digital signals to establish transformed digital signals which may then be stored in memory.

Some portions of the detailed description have been presented in terms of processes and/or symbolic representations of operations on data bits or binary digital signals stored within memory, such as memory within a computing system and/or other like computing device. These process descriptions and/or representations are the techniques used by those of ordinary skill in the data processing arts to convey the substance of their work to others skilled in the art. A process is here, and generally, considered to be a self-consistent sequence of operations and/or similar processing leading to a desired result. The operations and/or processing involve physical manipulations of physical quantities. Typically, although not necessarily, these quantities may take the form of electrical and/or magnetic signals capable of being stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with the appropriate physical quantities and are merely convenient labels. Unless specifically stated otherwise, as apparent from the following discussion, it is appreciated that throughout this specification discussions utilizing terms such as “processing”, “computing”, “calculating”, “associating”, “identifying”, “determining”, “allocating”, “establishing”, “accessing”, and/or the like refer to the actions and/or processes of a computing platform, such as a computer or a similar electronic computing device (including a special purpose computing device), that manipulates and/or transforms data represented as physical electronic and/or magnetic quantities within the computing platform's memories, registers, and/or other information (data) storage device(s), transmission device(s), and/or display device(s).

According to an implementation, one or more portions of an apparatus, such as computing device 200 (FIG. 2), for example, may store binary digital electronic signals representative of information expressed as a particular state of the device, here, computing device 200. For example, an electronic binary digital signal representative of information may be “stored” in a portion of memory 204 by affecting or changing the state of particular memory locations, for example, to represent information as binary digital electronic signals in the form of ones or zeros. As such, in a particular implementation of an apparatus, such a change of state of a portion of a memory within a device, such the state of particular memory locations, for example, to store a binary digital electronic signal representative of information constitutes a transformation of a physical thing, here, for example, memory device 204, to a different state or thing.

While certain exemplary techniques have been described and shown herein using various methods and apparatuses, it should be understood by those skilled in the art that various other modifications may be made, and equivalents may be substituted, without departing from claimed subject matter.

Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method comprising:
with at least one computing device:
identifying a search crowd based, at least in part, on one or more electrical signals representing a plurality of search queries received from two or more user devices;
maintaining information in the form of one or more electrical signals representing data associated with said search crowd; and
in response to subsequently receiving one or more electrical signals representing at least one other search query associated with said search crowd, providing at least a portion of said information in at least one search result response represented by one or more electrical signals.

2. The method as recited in claim 1, wherein identifying said search crowd further comprises:
identifying that two or more of said plurality of search queries are related;
establishing at least one search cluster based, at least in part, on two or more of said plurality of search queries identified as being related; and
establishing said search crowd based, at least in part, on said at least one search cluster.

3. The method as recited in claim 2, wherein establishing said search crowd further comprises:
establishing said search crowd based, at least in part, on one or more electrical signals representing at least one threshold value associated with at least one of: a measured time; a measured number of received search queries; and/or a measured number of search crowd members.

4. The method as recited in claim 1, wherein maintaining said information in the form of one or more electrical signals representing data associated with said search crowd further comprises associating one or more search results and/or search result summaries with said search crowd; and
wherein providing at least said portion of said information in at least said one search result response further comprises establishing at least said portion of said information to operatively affect a presentation of at least one of said search results and/or search result summaries via a display device.

5. The method as recited in claim 1, wherein maintaining said information in the form of one or more electrical signals representing data associated with said search crowd further comprises at least one of:
associating one or more search results and/or search result summaries with said search crowd;
identifying at least one user account and/or user device as a member of said search crowd;
identifying at least one member of said search crowd as being an active member or an inactive member;
assigning an identifier to said search crowd;
determining at least one time measurement associated with said search crowd;
determining a number of received search queries associated with said search crowd;
determining a number of search crowd members associated with said search crowd; and/or
determining user-related demographic information associated with member of said search crowd.

6. The method as recited in claim 1, wherein maintaining said information in the form of one or more electrical signals representing data associated with said search crowd further comprises:
affecting at least a part of said information based, at least in part, on at least one received input associated with at least one search crowd member; and/or
affecting at least a part of said information based, at least in part, on user-related demographic information associated with one or more search crowd members.

7. The method as recited in claim 1, further comprising:
managing one or more search crowds by at least one of:
selectively maintaining at least one search crowd comprising a number of search crowd members equal to or greater than zero;
selectively inactivating a given search crowd and/or reactivating a previously inactivated search crowd based, at least in part, on at least one threshold value associated with at least one of: a measured time; a measured number of received search queries; and/or a measured number of search crowd members;
selectively combining two or more existing search crowds into a single search crowd; and/or
selectively splitting an existing search crowd into two or more new search crowds.

8. An apparatus comprising:
memory:
a network interface; and
at least one processing unit to:
identify a search crowd based, at least in part, on a plurality of search queries received from two or more user devices via said network interface;
establish information associated with said search crowd in said memory; and
in response to at least one other search query associated with said search crowd, initiate transmission of at least a portion of said information in at least one search result response via said network interface.

9. The apparatus as recited in claim 8, said at least one processing unit to further:
identify that two or more of said plurality of search queries are related;
establish at least one search cluster based, at least in part, on two or more of said plurality of search queries identified as being related; and
establish said search crowd based, at least in part, on said at least one search cluster.

10. The apparatus as recited in claim 9, said at least one processing unit to further:
establish said search crowd based, at least in part, on at least one threshold value associated with at least one of: a measured time; a measured number of received search queries; and/or a measured number of search crowd members.

11. The apparatus as recited in claim 8, said at least one processing unit to further:
associate one or more search results and/or search result summaries with said search crowd; and
establish at least said portion of said information to operatively affect a presentation of at least one of said search results and/or search result summaries upon rendering via a display device.

12. The apparatus as recited in claim 8, said at least one processing unit to further:
associate one or more search results and/or search result summaries with said search crowd; and/or
identify at least one user account and/or user device as a member of said search crowd; and/or
identify at least one member of said search crowd as being an active member or an inactive member; and/or
assign an identifier to said search crowd; and/or
determine at least one time measurement associated with said search crowd; and/or
determine a number of received search queries associated with said search crowd; and/or
determine a number of search crowd members associated with said search crowd; and/or
determine user-related demographic information associated with member of said search crowd.

13. The apparatus as recited in claim 8, said at least one processing unit to further:
affect at least a part of said information based, at least in part, on at least one received input associated with at least one search crowd member; and/or
affect at least a part of said information based, at least in part, on user-related demographic information associated with one or more search crowd members.

14. The apparatus as recited in claim 8, said at least one processing unit to further:
selectively maintain at least one search crowd comprising a number of search crowd members equal to or greater than zero; and/or
selectively inactivate a given search crowd and/or reactivate a previously inactivated search crowd based, at least in part, on at least one threshold value associated with at least one of: a measured time; a measured number of received search queries; and/or a measured number of search crowd members; and/or
selectively combine two or more existing search crowds into a single search crowd; and/or
selectively subdivide an existing search crowd into two or more new search crowds.

15. An apparatus comprising:
a computer-readable medium having computer-implementable instructions stored thereon implementable by one or more processing units to:
identify a search crowd based, at least in part, on a plurality of search queries associated with two or more user devices;
establish information associated with said search crowd; and
in response to at least one other search query associated with said search crowd, initiate transmission of at least a portion of said information in at least one search result response.

16. The apparatus as recited in claim 15, said computer-implementable instructions being further implementable by said one or more processing units to:
identify that two or more of said plurality of search queries are related;
establish at least one search cluster based, at least in part, on two or more of said plurality of search queries identified as being related; and
establish said search crowd based, at least in part, on said at least one search cluster and on at least one threshold value associated with at least one of: a measured time; a measured number of received search queries; and/or a measured number of search crowd members.

17. The apparatus as recited in claim 15, said computer-implementable instructions being further implementable by said one or more processing units to:
associate one or more search results and/or search result summaries with said search crowd; and
establish at least said portion of said information to operatively affect a presentation of at least one of said search results and/or search result summaries upon rendering via a display device.

18. The apparatus as recited in claim 15, said computer-implementable instructions being further implementable by said one or more processing units to:
associate one or more search results and/or search result summaries with said search crowd; and/or
identify at least one user account and/or user device as a member of said search crowd; and/or
identify at least one member of said search crowd as being an active member or an inactive member; and/or
assign an identifier to said search crowd; and/or
determine at least one time measurement associated with said search crowd; and/or
determine a number of received search queries associated with said search crowd; and/or
determine a number of search crowd members associated with said search crowd; and/or
determine user-related demographic information associated with member of said search crowd.

19. The apparatus as recited in claim 15, said computer-implementable instructions being further implementable by said one or more processing units to:
affect at least a part of said information based, at least in part, on at least one received input associated with at least one search crowd member; and/or
affect at least a part of said information based, at least in part, on user-related demographic information associated with one or more search crowd members.

20. The apparatus as recited in claim 15, said computer-implementable instructions being further implementable by said one or more processing units to:
selectively maintain at least one search crowd comprising a number of search crowd members equal to or greater than zero; and/or
selectively inactivate a given search crowd and/or reactivate a previously inactivated search crowd based, at least in part, at least one threshold value associated with at least one of: a measured time; a measured number of received search queries; and/or a measured number of search crowd members; and/or
selectively combine two or more existing search crowds into a single search crowd; and/or
selectively subdivide an existing search crowd into two or more new search crowds.
